(19) United States
(12) Patent Application Publication
(10) Pub. No.: US 2026/0233506 A1
(43) Pub. Date: Aug. 13, 2026

(54) Laminator with Internal Temperature Conducting Device of Heating Shaft and Film Jamming Preventing Device Inside Rubber-Covered Roll

(71) Applicant: Huizhou Dexin Technology Co., Ltd, Huizhou (CN)

(72) Inventor: Shirong ZHU, Huizhou (CN)

(21) Appl. No.: 19/049,011

(22) Filed: Feb. 10, 2025

(51) Int. Cl. B32B 41/00; B32B 37/00; B32B 37/06

(52) U.S. Cl. CPC B32B 41/00; B32B 37/0053; B32B 37/06

(57) ABSTRACT

Disclosed is a laminator with an internal temperature conducting device of a heating shaft and a film jamming preventing device inside a rubber-covered roll. At least two rubber-covered rolls are arranged in parallel up and down on a rubber-covered roll bracket. A rotary driving mechanism is in transmission connection to the rubber-covered rolls and is capable of driving the rubber-covered rolls to rotate axially on the rubber-covered roll bracket. A heating tube extending axially and a temperature conducting device extending axially are arranged inside each of the rubber-covered rolls. According to the disclosure, the whole rubber-covered rolls can be uniformly heated, and the temperature of the rubber-covered rolls can be measured reliably, so that the temperature of the rubber-covered rolls is controlled accurately. The disclosure further can prevent a film jamming phenomenon.

### TECHNICAL FIELD

The disclosure relates to a laminator, and particularly relates to a laminator with an internal temperature conducting device of a heating shaft and a film jamming preventing device inside a rubber-covered roll.

### BACKGROUND

In an existing laminator, a rubber-covered roll is heated or temperature-sensed from the outside of the rubber-covered roll, which not only occupies a large space, making it difficult to miniaturize the size of the laminator, but also often results in uneven heating of the rubber-covered roll and inaccurate heating control of the rubber-covered roll, resulting in phenomena that the temperature of the rubber-covered roll is imbalanced, the rubber-covered roll is easily burnt, and external parts are damaged. In addition, in a current laminating process, a film jamming phenomenon caused by reverse placement of an adhesive film and excessive temperature often occurs, and thus the adhesive film cannot be exported smoothly.

### SUMMARY

To overcome deficiencies in the prior art, the disclosure is to provide a laminator with an internal temperature conducting device of a heating shaft and a film jamming preventing device inside a rubber-covered roll.

In order to achieve the above objective, the disclosure adopts the following technical solution:

A laminator with an internal temperature conducting device of a heating shaft and a film jamming preventing device inside a rubber-covered roll, including a rubber-covered roll, a rubber-covered roll bracket, and a rotary driving mechanism, where at least two rubber-covered rolls are arranged in parallel up and down on the rubber-covered roll bracket; a rotary driving mechanism is in transmission connection to the rubber-covered rolls and is capable of driving the rubber-covered rolls to rotate axially on the rubber-covered roll bracket; a heating tube extending axially and a temperature conducting device extending axially are arranged inside each of the rubber-covered rolls, the rubber-covered roll is fitted over the temperature conducting device, the temperature conducting device is fitted over the heating tube, and heat transfer between the heating tube and the rubber-covered roll is achieved through the temperature conducting device; and the temperature conducting device is connected to a temperature controller, and the temperature controller is configured to collect temperature data of the temperature conducting device so as to obtain the temperature of the rubber-covered rolls and control opening or closing of the heating tube accordingly.

Further, the temperature conducting device fixedly sleeves the heating tube, and the rubber-covered roll sleeves the temperature conducting device in an axial rotating manner; both ends of the heating tube and the temperature conducting device extend out of the rubber-covered rolls, at least one end of the heating tube is fixedly connected to the rubber-covered roll bracket, one end of the temperature conducting device is connected to the temperature controller through an extension member, and the temperature controller is fixed to the rubber-covered roll bracket.

Further, the rubber-covered roll bracket is connected to an end of the heating tube through a heating tube fixing bracket, and the end of the heating tube passes through and is fixed to the heating tube fixing bracket and is sleeved with a heating tube anti-vibration pad.

Further, the rotary driving mechanism includes a motor, a driving wheel, and rubber-covered roll wheels, and the motor is in transmission connection to the driving wheel and is configured to drive the driving wheel to rotate; and at least one rubber-covered roll wheel is coaxially fixed to each of the rubber-covered rolls, the driving wheel is in meshing transmission connection to one of the rubber-covered roll wheels, and the rubber-covered roll wheels are in meshing transmission connection with each other.

Further, the laminator further includes a film jamming preventing device, where the film jamming preventing device includes an upper adhesive guiding plate and a lower adhesive guiding plate, the upper adhesive guiding plate and the lower adhesive guiding plate are fixed to the rubber-covered roll bracket, the upper adhesive guiding plate and the lower adhesive guiding plate correspond to the rubber-covered rolls above and below respectively, and a jamming preventing sheet is arranged on one side of each of the upper adhesive guiding plate and the lower adhesive guiding plate toward the rubber-covered rolls; jamming preventing slots are formed in the rubber-covered rolls above and below, and the jamming preventing slot continuously extends circumferentially on an outer surface of the rubber-covered roll without interruption; the jamming preventing slot of the rubber-covered roll above corresponds to the jamming preventing sheet of the upper adhesive guiding plate in position, the jamming preventing slot of the rubber-covered roll below corresponds to the jamming preventing sheet of the lower adhesive guiding plate in position, and each of the jamming preventing sheets stretches into the jamming preventing slot at the corresponding position.

Further, the upper adhesive guiding plate and the lower adhesive guiding plate face one side of each of the rubber-covered rolls where a film is discharged; and a film discharging gap is arranged between the upper adhesive guiding plate and the lower adhesive guiding plate, and the film discharging gap is opposite to the position between the rubber-covered rolls above and below.

Further, a plurality of jamming preventing sheets are axially and uniformly arranged on one side of each of the upper adhesive guiding plate and the lower adhesive guiding plate facing the rubber-covered rolls, a plurality of jamming preventing slots are axially and uniformly formed in the rubber-covered rolls above and below, the jamming preventing slots of the rubber-covered roll above correspond to the jamming preventing sheets of the upper adhesive guiding plate one by one, and the jamming preventing slots of the rubber-covered roll below correspond to the jamming preventing sheets of the lower adhesive guiding plate one by one.

The disclosure has the following beneficial effects:
1. According to the disclosure, the heating tube and the temperature conducting device extending axially along the rubber-covered roll are arranged in the rubber-covered roll; with heating through the heating tube and transferring heat through the temperature conducting device, the whole rubber-covered roll can be uniformly heated, so that the temperature of the rubber-covered roll is balanced; the temperature of the rubber-covered roll can be measured reliably, so that the temperature of the rubber-covered roll is controlled accurately, the conditions that the rubber-covered roll is burnt due to high temperature is reduced, and the spaced occupied by heating devices can be effectively reduced, which facilitates miniaturization of the laminator.
2. By arranging the film jamming preventing device, the adhesive film and the rubber-covered roll can be effectively separated to prevent a film jamming phenomenon.

### BRIEF DESCRIPTION OF FIGURES

FIG. 1 is an overall schematic diagram of a laminator in an embodiment of the disclosure;

FIG. 2 is an exploded view of the laminator in the embodiment of the disclosure;

FIG. 3 is an exploded view of a rubber-covered roll in the embodiment of the disclosure;

FIG. 4 is a combined schematic diagram of rubber-covered rolls in the embodiment of the disclosure; and

FIG. 5 is a section view of the laminator in the embodiment of the disclosure.

### DETAILED DESCRIPTION

The disclosure will be further described below in conjunction with drawings. It is to be noted that based on the premise of the technical solution, the disclosure provides a detailed embodiment and specific operating processes. But the protection scope of the disclosure is not limited to the embodiment.

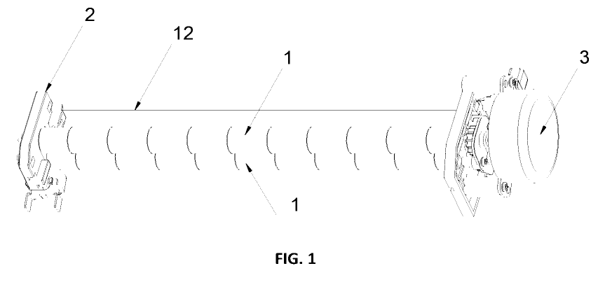

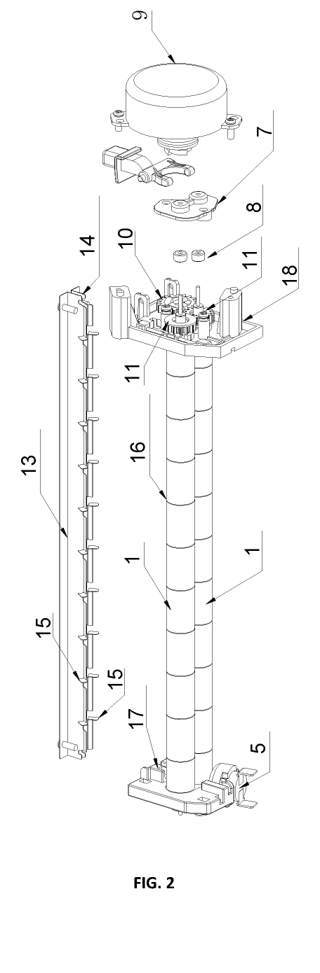

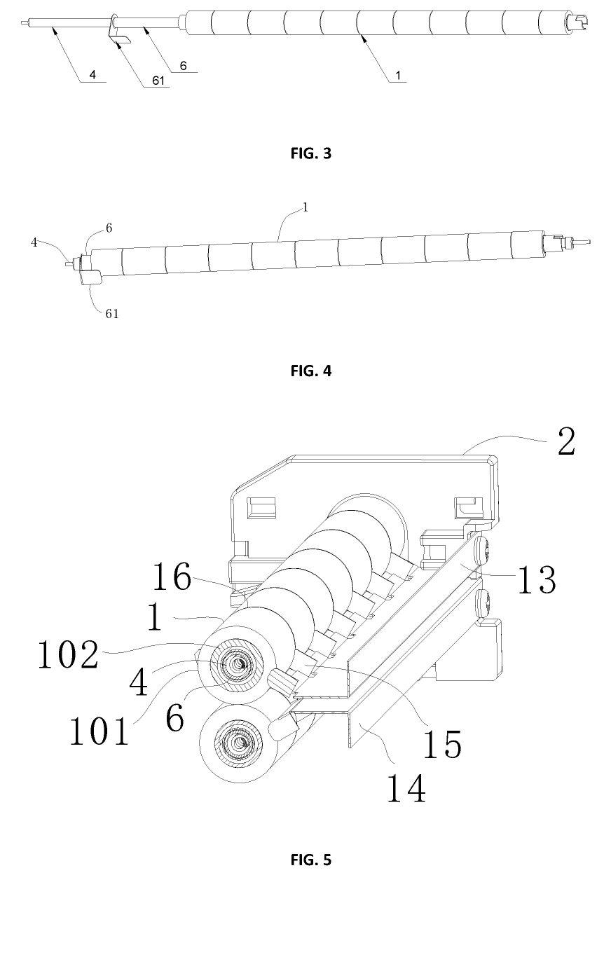

The embodiment provides a laminator with an internal temperature conducting device of a heating shaft and a film jamming preventing device inside a rubber-covered roll, as shown in FIGS. 1-5, including a rubber-covered roll 1, a rubber-covered roll bracket 2, and a rotary driving mechanism 3. At least two rubber-covered rolls 1 (two are shown in FIG. 1 in the embodiment) are arranged in parallel up and down on the rubber-covered roll bracket 2. A rotary driving mechanism 3 is in transmission connection to the rubber-covered rolls 1 and is capable of driving the rubber-covered rolls 1 to rotate axially on the rubber-covered roll bracket 2. A heating tube 4 extending axially and a temperature conducting device 6 extending axially are arranged inside each of the rubber-covered rolls 1. The rubber-covered rolls 1 are fitted over the temperature conducting device 6. The temperature conducting device 6 is fitted over the heating tube 4. Heat transfer between the heating tube 4 and the rubber-covered roll 1 is achieved through the temperature conducting device 6. The temperature conducting device 6 is connected to a temperature controller 5. The temperature controller 5 is configured to collect temperature data of the temperature conducting device 6 so as to obtain the temperature of the rubber-covered rolls 1 and control opening or closing of the heating tube 4 accordingly.

In the above laminator, when the heating tube heats, heat is radiated to the rubber-covered roll through the temperature conducting device. When the temperature of the rubber-covered roll is detected, since the temperatures of the temperature conducting device and the rubber-covered rolls achieve balance, the temperature controller can collect the temperature of the temperature conducting device to obtain the temperature of the rubber-covered roll and control start and stop of the heating tube accordingly.

In the embodiment, the temperature conducting device 6 fixedly sleeves the heating tube 4. The rubber-covered roll 1 sleeves the temperature conducting device 6 in an axial rotating manner. Both ends of the heating tube 4 and the temperature conducting device 6 extend out of the rubber-covered rolls 1. At least one end of the heating tube 4 is fixedly connected to the rubber-covered roll bracket 2. One end of the temperature conducting device 6 is connected to the temperature controller 5 through an extension member 61. The temperature controller 5 is fixed to the rubber-covered roll bracket 2. When the rubber-covered roll 1 rotates axially, the heating tube 4 and the temperature conducting device 6 do not rotate therewith, so that the connecting stability among the heating tube 4, the temperature conducting device 6, and the temperature controller 5 can be guaranteed. Specifically, both ends of the heating tube 4 in the embodiment are fixedly connected to both ends of the rubber-covered roll bracket 2, respectively.

Specifically, in the embodiment, the rubber-covered roll 1 includes a hollow iron core 102 and a silica gel 101 coating an outer surface of the hollow iron core 102. The temperature conducting device 6 is made of a metal material and suspends in the hollow iron core 102. The temperature conducting device 6 does not contact with the hollow iron core and transfers heat by thermal radiation.

In the embodiment, the rubber-covered roll bracket 2 is connected to an end of the heating tube 4 through a heating tube fixing bracket 7. The end of the heating tube 4 passes through and is fixed to the heating tube fixing bracket 7 and is sleeved with a heating tube anti-vibration pad 8. Through the heating tube anti-vibration pad, the influence of rotation of the rubber-covered roll on the heating tube can be reduced, thereby playing roles of protecting the heating tube and preventing the heating tube from being damaged.

In the embodiment, the rotary driving mechanism includes a motor 9, a driving wheel 10, and rubber-covered roll wheels 11. The motor 9 is in transmission connection to the driving wheel 10 and is configured to drive the driving wheel 10 to rotate. At least one rubber-covered roll wheel 11 is coaxially fixed to each of the rubber-covered rolls 1. The driving wheel 10 is in meshing transmission connection to one of the rubber-covered roll wheels 11. The rubber-covered roll wheels 11 are in meshing transmission connection with each other. After the motor is started, the driving wheel starts to rotate to drive the meshed rubber-covered roll wheel to rotate, so as to drive other rubber-covered roll wheels to rotate, so that the rubber-covered rolls 1 rotate synchronously.

In the embodiment, the laminator further includes a film jamming preventing device 12. The film jamming preventing device 12 includes an upper adhesive guiding plate 13 and a lower adhesive guiding plate 14. The upper adhesive guiding plate 13 and the lower adhesive guiding plate 14 are fixed to the rubber-covered roll bracket 2. The upper adhesive guiding plate 13 and the lower adhesive guiding plate 14 correspond to the rubber-covered rolls 1 above and below respectively. A jamming preventing sheet 15 is arranged on one side of each of the upper adhesive guiding plate 13 and the lower adhesive guiding plate 14 toward the rubber-covered rolls 1. Jamming preventing slots 16 are formed in the rubber-covered rolls 1 above and below. The jamming preventing slot 16 continuously extends circumferentially on an outer surface of the rubber-covered roll 1 without interruption. The jamming preventing slot 16 of the rubber-covered roll 1 above corresponds to the jamming preventing sheet 15 of the upper adhesive guiding plate 13 in position. The jamming preventing slot 16 of the rubber-covered roll 1 below corresponds to the jamming preventing sheet 15 of the lower adhesive guiding plate 14 in position. Each of the jamming preventing sheets 15 stretches into the jamming preventing slot 16 at the corresponding position.

By arranging the jamming preventing slots on the rubber-covered rolls and arranging the jamming preventing sheets stretching into the jamming preventing slots, in the rotating process of the rubber-covered rolls, if the rubber-covered rolls and the adhesive film are adhered and cannot be separated, when the rubber-covered rolls continue to rotate, the jamming preventing sheets stretching into the jamming preventing slots can block the adhesive film adhered to the surfaces of the rubber-covered rolls to prevent the adhesive film from rolling up with the rotation of the rubber-covered rolls continuously and promote the adhesive film to be separated from the surfaces of the rubber-covered rolls, thereby playing a role of preventing film jamming.

Further, in the embodiment, the upper adhesive guiding plate 13 and the lower adhesive guiding plate 14 face one side of each of the rubber-covered rolls 1 where a film is discharged. A film discharging gap is arranged between the upper adhesive guiding plate 13 and the lower adhesive guiding plate 14. The film discharging gap is opposite to the position between the rubber-covered rolls above and below.

Further, in the embodiment, a plurality of jamming preventing sheets 15 are axially and uniformly arranged on one side of each of the upper adhesive guiding plate 13 and the lower adhesive guiding plate 14 facing the rubber-covered rolls 1. A plurality of jamming preventing slots 16 are axially and uniformly formed in the rubber-covered rolls 1 above and below. The jamming preventing slots 16 of the rubber-covered roll 1 above correspond to the jamming preventing sheets 15 of the upper adhesive guiding plate 13 one by one. The jamming preventing slots 16 of the rubber-covered roll 1 below correspond to the jamming preventing sheets 15 of the lower adhesive guiding plate one by one.

Specifically, the jamming preventing sheets 15 may be ratchet jamming preventing sheets.

In the embodiment, the rubber-covered roll bracket 2 includes a left bracket 17 and a right bracket 18.

Persons skilled in the art can make various corresponding changes and transformations according to the above technical solution and concept, and all the changes and transformations shall fall within the protection scope of the claims of the disclosure.

What is claimed is:

1. A laminator with an internal temperature conducting device of a heating shaft and a film jamming preventing device inside a rubber-covered roll, comprising a rubber-covered roll, a rubber-covered roll bracket, and a rotary driving mechanism, wherein at least two rubber-covered rolls are arranged in parallel up and down on the rubber-covered roll bracket; a rotary driving mechanism is in transmission connection to the rubber-covered rolls and is capable of driving the rubber-covered rolls to rotate axially on the rubber-covered roll bracket. A heating tube extending axially and a temperature conducting device extending axially are arranged inside each of the rubber-covered rolls, the rubber-covered roll is fitted over the temperature conducting device, the temperature conducting device is fitted over the heating tube, and heat transfer between the heating tube and the rubber-covered roll is achieved through the temperature conducting device; and the temperature conducting device is connected to a temperature controller, and the temperature controller is configured to collect temperature data of the temperature conducting device so as to obtain the temperature of the rubber-covered roll and control opening or closing of the heating tube accordingly.

2. The laminator according to claim 1, wherein the temperature conducting device fixedly sleeves the heating tube, and the rubber-covered roll sleeves the temperature conducting device in an axial rotating manner; both ends of the heating tube and the temperature conducting device extend out of the rubber-covered roll, at least one end of the heating tube is fixedly connected to the rubber-covered roll bracket, one end of the temperature conducting device is connected to the temperature controller through an extension member, and the temperature controller is fixed to the rubber-covered roll bracket.

3. The laminator according to claim 1, wherein the rubber-covered roll bracket is connected to an end of the heating tube through a heating tube fixing bracket, and the end of the heating tube passes through and is fixed to the heating tube fixing bracket and is sleeved with a heating tube anti-vibration pad.

4. The laminator according to claim 1, wherein the rotary driving mechanism comprises a motor, a driving wheel, and rubber-covered roll wheels, and the motor is in transmission connection to the driving wheel and is configured to drive the driving wheel to rotate; and at least one rubber-covered roll wheel is coaxially fixed to each of the rubber-covered rolls, the driving wheel is in meshing transmission connection to one of the rubber-covered roll wheels, and the rubber-covered roll wheels are in meshing transmission connection with each other.

5. The laminator according to claim 1, further comprising a film jamming preventing device, wherein the film jamming preventing device comprises an upper adhesive guiding plate and a lower adhesive guiding plate, the upper adhesive guiding plate and the lower adhesive guiding plate are fixed to the rubber-covered roll bracket, the upper adhesive guiding plate and the lower adhesive guiding plate correspond to the rubber-covered rolls above and below respectively, and a jamming preventing sheet is arranged on one side of each of the upper adhesive guiding plate and the lower adhesive guiding plate toward the rubber-covered rolls; jamming preventing slots are formed in the rubber-covered rolls above and below, and the jamming preventing slot continuously extends circumferentially on an outer surface of the rubber-covered roll without interruption; the jamming preventing slot of the rubber-covered roll above corresponds to the jamming preventing sheet of the upper adhesive guiding plate in position, the jamming preventing slot of the rubber-covered roll below corresponds to the jamming preventing sheet of the lower adhesive guiding plate in position, and each of the jamming preventing sheets stretches into the jamming preventing slot at the corresponding position.

6. The laminator according to claim 5, wherein the upper adhesive guiding plate and the lower adhesive guiding plate face one side of each of the rubber-covered rolls where a film is discharged; and a film discharging gap is arranged between the upper adhesive guiding plate and the lower adhesive guiding plate, and the film discharging gap is opposite to the position between the rubber-covered rolls above and below.

7. The laminator according to claim 5, wherein a plurality of jamming preventing sheets are axially and uniformly arranged on one side of each of the upper adhesive guiding plate and the lower adhesive guiding plate facing the rubber-covered rolls, a plurality of jamming preventing slots are axially and uniformly formed in the rubber-covered rolls above and below, the jamming preventing slots of the rubber-covered roll above correspond to the jamming preventing sheets of the upper adhesive guiding plate one by one, and the jamming preventing slots of the rubber-covered roll below correspond to the jamming preventing sheets of the lower adhesive guiding plate one by one.
